(19) United States
(12) Patent Application Publication
(10) Pub. No.: US 2023/0303373 A1
(43) Pub. Date: Sep. 28, 2023

(54) TELEOPERATED MATERIAL HANDLING SYSTEM AND MATERIAL HANDLING VEHICLE

(71) Applicant: Logistics and Supply Chain MultiTech R&D Centre Limited, Pok Fu Lam (HK)

(72) Inventors: Leung Chiu, Pok Fu Lam (HK); Chi Fai Kwok, Pok Fu Lam (HK); Kin Keung Lee, Pok Fu Lam (HK); Ka Lun Fan, Pok Fu Lam (HK)

(21) Appl. No.: 17/709,607

(22) Filed: Mar. 31, 2022

(30) Foreign Application Priority Data
Mar. 25, 2022 (HK) 22022050649.1

(51) Int. Cl. B66F 9/075; G05D 1/00; G05D 1/02; G06T 7/579

(52) U.S. Cl. CPC B66F 9/07581; B66F 9/0755; G05D 1/0038; G05D 1/0022; G05D 1/0248; G05D 1/028; G05D 1/0278; G05D 1/027; G05D 1/0274; G05D 1/0061; G06T 7/579; G05D 2201/0216; G06T 2207/30252

(57) ABSTRACT

A teleoperated material handling system 100 includes a teleoperation terminal 10 for collecting mechanical inputs from a teleoperator and converting to operation commands, a material handling vehicle 20 with a load engaging device 21, a visual capturing module 22 for capturing video imagery in front of the material handling vehicle, a communication module 30 for establishing a communication link with the teleoperation terminal for transmitting the video imagery to the teleoperation terminal and receiving the operation commands, and a control module 40 for controlling operations of the material handling vehicle and the load engaging device. The system further includes an assistive module 50 providing an assistive indicator to the teleoperator through the teleoperation terminal, the assistive indicator 51 is dynamic with respect to changes in the operation commands, and provides visual guidance for the teleoperator in maneuvering the load engaging device.

### FIELD OF THE INVENTION

The present invention relates to a material handling system. Particularly, the present invention pertains to a material handling system offering teleoperation capabilities and various assistive features, as well as a material handling vehicle incorporating assistive features.

### BACKGROUND

In a warehouse, material handling vehicles work collaboratively with warehouse personnel, whether that is moving stock during picking, retrieving replenishment or transferring bulk stock. They transport batches to the next stage of processing, allowing workers to move on to their next task. Movement-related capabilities include pallet movement, carts, movement of shelving and racking, and many other material movement tasks within the warehouse.

Generally, manual labor is typically required to receive, store, perform inventory audit, and retrieval for the goods or produce. Managing the operations of the warehouse and minimizing the costs of operations and transportation can often be a challenge. Typically, warehouse operators employ material handling vehicles, such as forklifts or pallet stackers, to reduce the dependency on labor intensive tasks in the warehouse. However, these machineries require dedicated and skilled operators or drivers in order to carry out its intended functions safely and effectively. Accordingly, in the midst of warehouse labor shortages, there exists the need for a teleoperated system for use with material handling vehicles for improving warehouse operating productivity.

Teleoperation of a material handling vehicle refers to the ability to remotely drive or assist a self-operating material handling vehicle. Most leading companies in the industry believe that to bridge the gap between current self-driving capabilities and the requirements needed for widespread adoption of autonomous material handling vehicles, there is a need for teleoperation capabilities for assisting these self-operating vehicles, in situations where the autonomous software stack has low confidence level in its ability to perform the correct action, or when the material handling vehicle need to operate outside of its standard operating parameters. Without the ability to be teleoperated, in such situations the autonomous vehicle would transition to a Minimum Risk Maneuverer (MRM) which would undesirably put its operation on halt. Even with teleoperation of the material handling vehicle is available, remote controlling the teleoperable vehicle through only a video feed has proven to be exceptionally challenging for most warehouse operators. In many cases, a teleoperator would find difficulties in maneuvering the material handling vehicle because they would not be able to sense small movements, change in speed, or to contemplate a curvature of a turn, etc. Further, due to different lighting conditions in the warehouse and the lack of clear depth perception provided by the display, there may not provide satisfactory visual feedback for the teleoperator to accurately align the load engaging device, such as a lifting fork, with an object to the lifted or transported. All these shortcomings would hinder the performance and efficiency of a teleoperated material handling system.

### SUMMARY OF THE INVENTION

The present invention proposes to alleviate or to at least mitigate some of the above shortcomings by providing an improved teleoperated material handling system and a material handling vehicle. According to a first aspect of the present invention, there is provided a teleoperated material handling system, comprising:
a teleoperation terminal configured for collecting mechanical inputs from a teleoperator and converting to operation commands;
a material handling vehicle with a load engaging device;
a visual capturing module for capturing video imagery in front of the material handling vehicle;
a communication module configured for establishing a communication link with the teleoperation terminal for transmitting the video imagery to the teleoperation terminal and receiving the operation commands from the teleoperation terminal for controlling the material handling vehicle and the load engaging device; and
a control module for controlling operations of the material handling vehicle according to the operation commands;
wherein the system comprises an assistive module configured for providing one or more assistive indicators to the teleoperator through the teleoperation terminal, the one or more assistive indicators are dynamic with respect to changes in the operation commands, the one or more assistive indicators provide visual guidance through the teleoperation terminal for the teleoperator to manoeuvre the load engaging device so as to facilitate an alignment with the bottom of the object.

In an embodiment, the one or more assistive indicators are superimposed over the video imagery on the display of the tele-operation terminal.

In an embodiment, the one or more assistive indicators comprises one or more trajectory lines representing an anticipated trajectory of movement of the material handling vehicle.

In an embodiment, the one or more trajectory lines changes with respect to a change in steering input by the teleoperator according to Ackerman steering geometry.

In an embodiment, the one or more trajectory lines change with respect to a change in a steering angle of the steering wheels.

In an embodiment, the one or more trajectory lines change with respect to a change in traveling speed of the material handling vehicle.

In an embodiment, perspective correction is performed for the one or more trajectory lines according to a perspective angle inherent in the video imagery.

In an embodiment, the one or more assistive indicators are formed by projecting one or more laser beams from the load engaging device to form one or more markings on a surface.

In an embodiment, the one or more assistive indicators are capturable and visible in the video imagery.

In an embodiment, the one or more laser beams projected from one or more laser markers mounted on one or more load engaging portions of the load engaging device.

In an embodiment, the one or more laser markers project one or more longitudinal lines align with the load engaging portion.

In an embodiment, the system comprises a beacon device for providing a tracking functionality for the material handling vehicle.

In an embodiment, the beacon device comprises a wearable carrier adapted to be worn by an onsite operator.

In an embodiment, the beacon device emits a beacon signal receivable by the control module on the material handling vehicle, the control module is adapted for determining a path of travel for the material handling vehicle with respect to the beacon signal.

In an embodiment, the material handling vehicle provides a front tracking mode such that the material handling vehicle travels along the path of travel with the material handling vehicle trailing the onsite operator carrying the beacon device.

In an embodiment, the material handling vehicle provides a rear tracking mode such that the material handling vehicle travels along the path of travel in front of the onsite operator carrying the beacon device.

In an embodiment, the system utilizes ultrawide band signal positioning to locate the beacon device for determining the path of travel.

In an embodiment, the material handling vehicle is switchable between different operation modes including manual operation mode, teleoperation mode, and autonomous operation mode.

In an embodiment, the material handling vehicle is switchable between different operation modes including manual operation mode, teleoperation mode, autonomous operation mode, front tracking mode and a rear tracking mode.

In an embodiment, the communication link utilizes wireless communication protocols according to 5G mobile communication standards.

In an embodiment, the communication link utilizes wireless communication protocols according to Wi-Fi standards.

In an embodiment, the material handling vehicle is configured for self-navigating based on Simultaneous Localization and Mapping (SLAM).

In an embodiment, the material handling vehicle is provided with a plurality of sensors comprising light detection and ranging (LiDAR), an inertial navigation system (INS), Global Positioning System (GPS), and high-definition maps (HD Map).

According to a second aspect of the present invention, there is provided a material handling vehicle, comprising:
a load engaging device;
a control module for controlling movement of the material handing vehicle;
an assistive module configured for providing one or more assistive indicators to an operator, the one or more assistive indicators are dynamic with respect to a change in position of the load engaging device;
wherein the one or more assistive indicators are formed by projecting one or more laser beams from the load engaging device to form one or more markings on an object for indicating alignment of the load engaging device with respect to the object.

In an embodiment, the one or more laser beams projected from one or more laser markers mounted on one or more load engaging portions of the load engaging device.

In an embodiment, the one or more laser markers project one or more longitudinal lines aligning with the load engaging portion.

In an embodiment, the control module is configured for receiving a beacon signal emitted by a beacon device carried by the operator, the control module is adapted for determining a path of travel for the material handling vehicle with respect to the beacon signal.

In an embodiment, the material handling vehicle provides a front tracking mode such that the material handling vehicle travels along the path of travel with the material handling vehicle trailing the operator carrying the beacon device.

In an embodiment, the material handling vehicle provides a rear tracking mode such that the material handling vehicle travels along the path of travel in front of the operator carrying the beacon device.

In an embodiment, the control module utilizes ultrawide band signal positioning to locate the beacon device for determining the path of travel.

### BRIEF DESCRIPTION OF THE DRAWINGS

FIG. 1 shows a block diagram of the teleoperated material handling system according to an embodiment of the invention;

FIG. 2 shows a drawing of a material handling vehicle of the system;

FIG. 3 shows a diagram of how trajectory lines are determined based on Ackerman steering geometry;

FIG. 4a shows a bird's eye view perspective of the trajectory lines;

FIG. 4b shows the trajectory lines after perspective correction;

FIG. 5a shows a screenshot of a video imagery superimposed with trajectory lines, in which the video imagery is taken by a front facing camera;

FIG. 5b shows a screenshot of a video imagery superimposed with trajectory lines, in which the video imagery is taken by a rear facing camera;

FIG. 6 shows a drawing of the material handling vehicle according to another embodiment;

FIG. 7a shows a picture of the material handling vehicle onsite;

FIG. 7b shows a video imagery taken by the front facing camera showing the assistive indicators;

FIG. 8 shows an illustration of the material handling vehicle in a front tracking mode; and

FIG. 9 shows an illustration of the material handling vehicle in a rear tracking mode.

### DESCRIPTION OF THE PREFERRED EMBODIMENTS

The following clearly and completely describes the technical solutions in the embodiments of the present invention with reference to the accompanying drawings. Apparently, the described embodiments are merely some but not all of the embodiments of the present invention. All other embodiments based on the embodiments of the present invention and obtained by a person of ordinary skill in the art without investing creative efforts shall fall within the scope of the present invention.

The teleoperated, or remote operated material handling system according to embodiments of the present invention serves to bridge the gap between current self-driving capabilities and the requirements needed for widespread adoption of autonomous vehicles by providing teleoperation capabilities with assistive functionalities which facilitates a teleoperator or an onsite operator to safely and efficiently perform the required operations, such as forklifting and transporting, in areas of material handling.

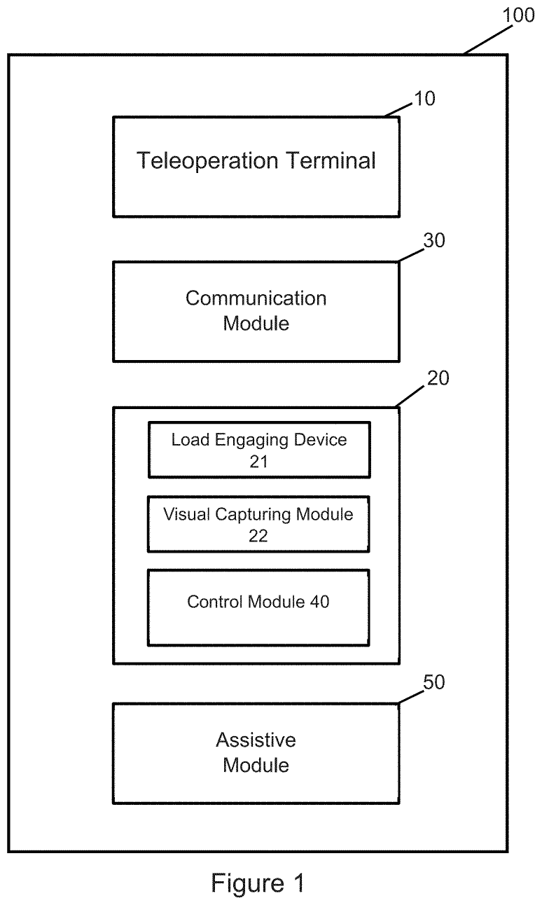

According to FIG. 1, the teleoperated material handling system 100 generally includes a teleoperation terminal 10 and a material handling vehicle 20 operable through the teleoperation terminal 10. The teleoperation terminal 10 is adapted for collecting mechanical inputs from a remote operator, such as a teleoperator, and converting the inputs into operation commands. For instance, the teleoperation terminal 10 may be provided with input devices such as steering wheel, pedals, shifters or levers resembling those found in a cockpit of a typical material handling vehicle. The arrangement of these input devices provided with the teleoperation terminal may imitate that of a conventional material handling vehicle, which provides the teleoperator the familiarity required for operating efficiently, and an immersive, realistic experience.

In an embodiment, the material handling vehicle 20 may be a motorized pallet stacker or a fork lift which is electrically powered, although other types of material handling vehicle, i.e., particularly those used in a warehouse, also fall within the scope of the invention. For instance, the material handling vehicle 20 is provided with a load engaging device 21. The load engaging device 21 may be a lifting fork or the lifting arm of the material handling vehicle 20. The load engaging device 21 is adapted to be movable, typically in a vertical manner, with respect to the material handling vehicle 20. In an embodiment, the material handling vehicle 20 is capable of being teleoperated and autonomously operated. The vehicle 20 may be provided with a plurality of sensors comprising light detection and ranging (LiDAR), an inertial navigation system (INS), Global Positioning System (GPS), and/or high-definition maps (HD Map) for supporting autonomous operability. For example, the vehicle 20 may be configured for self-navigating based on Simultaneous Localization and Mapping (SLAM) through the use of multi-sensor fusion based techniques. More preferably, the material handling vehicle 20 may also provide full manual operation capability allowing a physical operator or driver for direct onsite operation equivalenting to a conventional material handling vehicle.

In an embodiment, there are two modes in the teleoperation of the material handling vehicle 20. The first mode may be referred as “Direct Operation”, in which the teleoperator performs the driving of the vehicle dynamically, i.e., controlling the steering, acceleration, braking and load engaging, through the teleoperation terminal. The second mode may be referred as “High Level Command Operation”, in which the teleoperator merely supervises the autonomous vehicle by providing instructions, approving or correcting the vehicle's travel path or load engaging actions, without actually performing the operation. In some circumstances, switching between the two modes may be necessary, or a combination of both modes may be adopted. Optionally, the material handling vehicle 20 may be switchable between different operation modes including manual operation mode, teleoperation mode, autonomous operation mode, or other assistive operation modes.

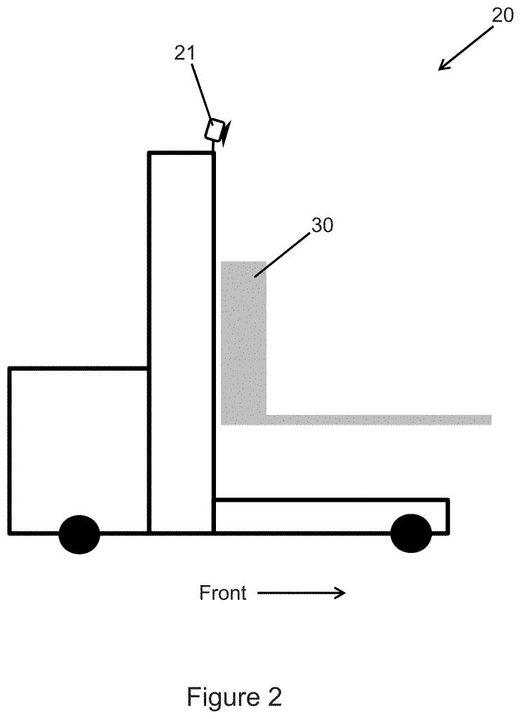

According to FIG. 2, an embodiment of the invention will be discussed based on an adaptation of a teleoperable and autonomously operable pallet stacker 20. The pallet stacker 20 is provided with a lifting fork 21 and a visual capturing module 22. Specifically, the visual capturing module 22 may include one or more video cameras. Preferably, individual video cameras may be provided at the front and rear of the material handling vehicle 20. Advantageously, the video cameras may be mounted at am elevated position to avoid being blocked by objects being carried on the vehicle during operation. The visual capturing module 22 includes at least a front facing camera 211 adapted for capturing a video imagery of at least a portion of the lifting fork 21 and the area ahead of the pallet stacker 20. Likewise, the visual capturing module 22 may also include a rear facing camera adapted for capturing a video imagery of at least a portion the area rearward of the pallet stacker 20.

The system 100 includes a communication module 30 for establishing a communication link with the teleoperation terminal 10 for transmitting the video imageries to the teleoperation terminal 10 for viewing on a display 11. The communication module 30 is configured for receiving the operation commands from the teleoperation terminal 10 to control the movement of the pallet stacker 20 and the operation of the lifting fork 21. Specifically, the communication module 30 may include a transceiver at both the teleoperation terminal 10 and the pallet stacker 20 for sending and receiving data therebetween. Preferably, the communication link would have a very low-latency, such as <5 ms, and more preferably, about 1 ms. Preferably, the communication link may utilize low latency wireless communication protocols including, but not limiting to, 5G mobile communication standards, Wi-Fi standards, or a combination of both. For example, video imageries may be captured onsite by the video capturing module 22 and transmitted to the teleoperation terminal 10 through the use of the 5G mobile communication network, while the operation commands, generated by the mechanical input by the teleoperator, may be transmitted to the pallet stacker by Wi-Fi, or vice versa. Based on the operation commands received from the teleoperation terminal 10, a control module 50 on the pallet stacker controls the movement as well as other functionalities of pallet stacker 20, including but not limiting to moving the pallet stacker forward, backward, steer left/right, raising or lowering the lifting fork 21, etc.

According to an embodiment, the teleoperated material handling system 100 includes an assistive module 50 configured for providing one or more assistive indicators to the teleoperator through the teleoperation terminal 10. The one or more assistive indicators serve to assist the teleoperator in maneuvering the pallet stacker 20 and/or operating the lifting fork 21 with respect to an object, i.e., a load such as a pallet of goods, and provide visual guidance through the teleoperation terminal 10 for the teleoperator to manoeuvre the lifting fork 21 so as to facilitate an alignment with the bottom of the object. For example, the one or more assistive indicators may serve to assist the teleoperator to judge how tight a turn is required to be made in order to align the lifting fork 21 with a bottom slot of the pallet. In general, the one or more assistive indicators would be able to provide assistive guidance to the teleoperator in maneuvering the lifting fork 21 along the way to the object, and preferably, fine tuning movements of the lifting fork 21 for engaging the object.

In an embodiment, the one or more assistive indicators may be dynamic such that they change with respect to a change in the operation commands in real time. According to an embodiment, the assistive indicator includes one or more trajectory lines superimposed over the video imagery on the display of the teleoperation terminal 10. Specifically, the one or more trajectory lines represent an anticipated trajectory of movement of the pallet stacker 20 based on the steering input by the teleoperator, while the anticipated trajectory changes with respect to a change in steering input by the teleoperator.

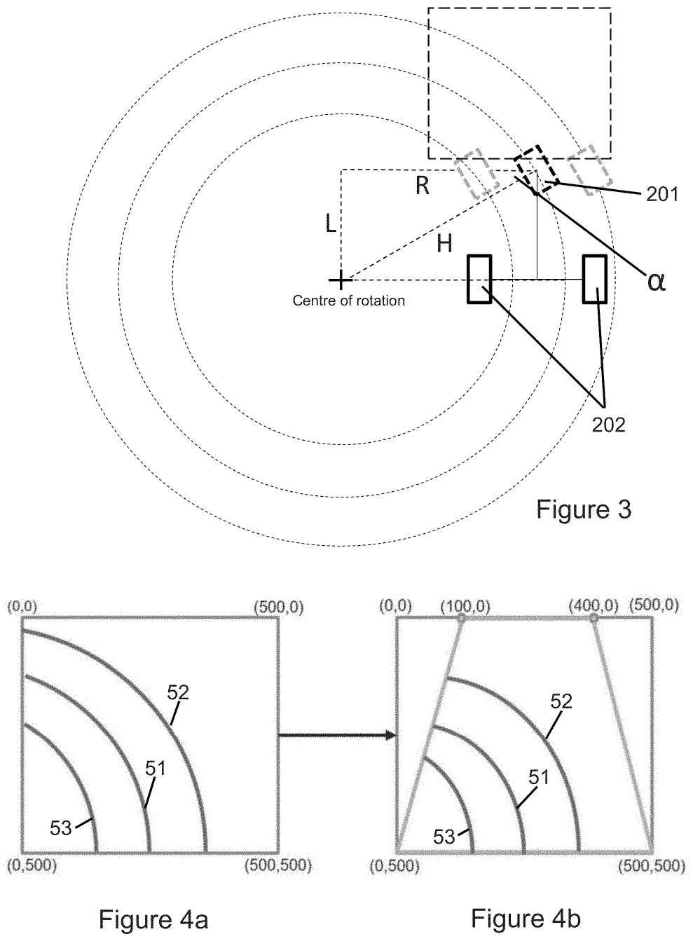

In a specific example, the pallet stacker 20 has three wheels, with a single wheel 201 in front axle and two wheels 202 in the rear axle, as shown in FIG. 3. The front axle is a steerable axle with an angular sensor configured for determining a steering angle α of the single steerable wheel 201. The distance between the front axle and the rear axle is the wheelbase L, which is known. As shown, based on the Ackerman steering geometry the turning radius can be determined based on the following:

R=L/tan (α)

The assistive module, based on the above geometric relationship, determines a trajectory radius H which the steerable wheel follows by:

H=L/sin (α)

With trajectory radius H with respect to the steering angle α at any point being known, the curvature of the trajectory line 51 of steerable wheel 201, which is based on trajectory radius H, can therefore be determined. Further, the trajectory line of each of the rear wheels, or any part of the pallet stacker 20, can also be determined based on known measurements. Referring to FIG. 4a, the assistive module determines the trajectory line 51 of the steerable wheel 201 with a curvature corresponding to a steering angle α according to a bird's eye perspective. The trajectory lines 51 as shown represent a predicted path which the pallet stacker 20 will follow with the steering angle α remains at its current value. More trajectory lines may be incorporated to enhance the guidance of the pallet stacker 20 along the anticipated path. Preferably, two outer trajectory lines 52, 53 may be used to represent the trajectories of the two side extremities of the pallet stacker 20. Alternatively, two outer trajectory lines may be used to represent the trajectories of the two rear wheels 202, whereas each of the rear wheels 202 has their own turning radius R for determining the curvature of the respective outer trajectory lines. In the event the steering angle α is zero, the trajectory lines 51, 52, 53 would appear as straight lines representing that the pallet stack 20 is predicted to follow a straight path of travel.

To superimpose the trajectory lines 51, 52, 53 over the video imagery captured by the visual capturing module, i.e., the camera, the assistive module applies a perspective correction to compensate for the perspective angle inherent in the video imagery. For example, to optimize visibility the camera is usually mounted at a position near the roofline of the pallet stacker 20, as shown in FIG. 2. The ground surface in the video imagery would be captured at a perspective angle. Based on the elevation and angle of the camera is mounted with respect to the ground surface, a suitable perspective transformation or correction would be applied to the trajectory lines 51, 52, 53 for aligning with the ground surface in the video imagery. As shown in FIG. 4b, perspective transformation is applied to the trajectory lines 51, 52, 53 for mapping with the ground surface that is captured at a perspective angle in the video imagery.

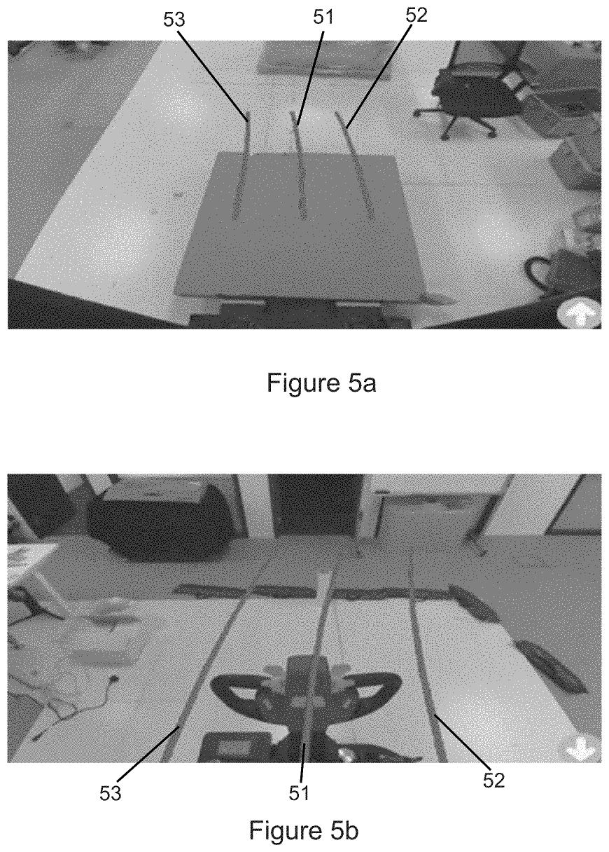

After perspective correction is applied on the trajectory lines 51, 52, 53, the lines are superimposed on video imagery in a manner as shown in FIGS. 5a and 5b. As seen, the trajectory lines 51, 52, 53 clearly indicate a predicted path of travel according to the steering angle α. The curvatures of the trajectory lines 51, 52, 53 change with respect to a change in a steering angle α which is controlled by the teleoperator. Advantageously, the trajectory lines 51, 52, 53 can provide visual guidance to the teleoperator to maneuverer the pallet stacker 20 in avoidance of contacting or colliding with obstacles in the surroundings. Optionally, the characteristics of the trajectory lines 51, 52, 53 may also be determined by taking into account of the parameters such as moving speed, moving direction and steering angle.

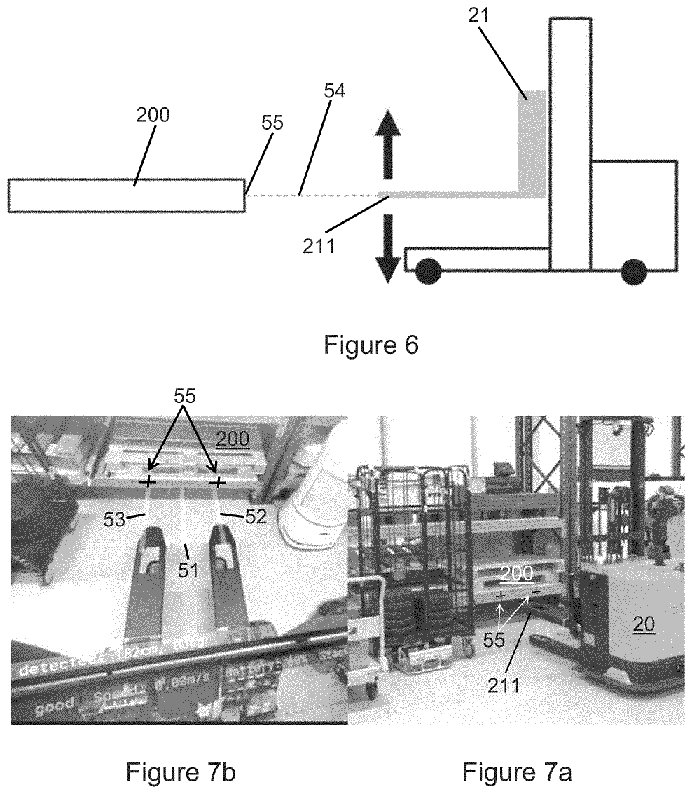

The assistive indicators may include those visible in physical site and capturable in the video imagery, as shown in FIG. 7a. For example, such assistive indicator may be formed by projecting one or more laser beams 54 from the load engaging device 21, i.e., the lifting fork, to form one or more markings 55 on an object, whereas the one or more markings 55 is captured by the visual capturing module 22 which is visible in the video imagery being displayed at the teleoperation terminal 10. Preferably, one or more laser markers (not shown) may be mounted on the fork lifter 21 of the pallet stacker 20 in the manner as shown in FIG. 6. The one or more laser markers may be mounted substantially levelled with the lifting fork 21. More preferably, one laser marker may be mounted at each of the engaging portions 211 of the lifting fork 21 such that it substantially aligns with the lengthwise direction of the lifting fork 21. Each of the laser markers moves with the lifting fork 21 while projecting a marking 55 on a side surface of an object 200, i.e., a pallet of goods. As shown in FIG. 7b, the one or more markings 55 can be captured by the visual capturing module 22 and is visible to the teleoperator through the display of teleoperation terminal 10, whilst the trajectory lines 51, 52, 53 are augmented on the video imagery. Preferably, each of the markings 55 may be a crosshair representing the alignment of the respective engaging portions 211 with respect to the object 200, which enables the teleoperator to align the lifting fork 21 for proper engagement with the pallet 200. As clearly shown in FIG. 7a or 7b, the crosshair markings 55 sit slightly below the pallet indicating that the load engaging portions 211 of the lifting fork 21 is required to be raised slightly in order to engage with the slot of the pallet 200. Optionally, the one or more laser markers may also project one or more straight longitudinal lines, i.e., downward on the ground, for indicating spatial alignment of the lifting fork 21 relative to the pallet 200. The longitudinal lines substantially align with the load engaging portions 211 and can serve as additional guidance for the teleoperator when engaging the pallet 200. as shown. Through observing the markings 55, the teleoperator would be able to determine the relative position of the lifting fork 21 with respect to the pallet 200 and thus be able to accurately engage the load engaging portions 211 with the slots of the pallet 200. Alternatively, the above assistive functionalities may also be implemented on manual operated material handling vehicles, such as a conventional pallet stacker, as the markings are directly visible to the operator.

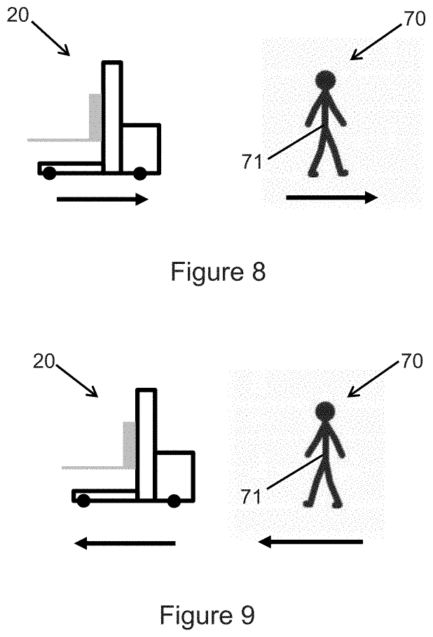

Referring to FIG. 8 and FIG. 9, the assistive module provides tracking functionalities for the pallet stacker 20 when being operated onsite by a warehouse personnel, such as an onsite operator or a co-operator, who has assumed an assistive role to the teleoperator. For example, the system 100 includes a beacon device 71 for carrying by the operator 70. Advantageously, the beacon device 71 may include a wearable carrier adapted for being worn by the onsite operator 70 so that the beacon device 71 does not occupy any of the hands of the operator 70. The beacon device 71 is configured to emit a beacon signal receivable by the control module 40 on the pallet stacker 20. More preferably, the beacon device 71 may utilize ultrawide band signal positioning to locate or pinpoint the beacon device 71 and allows the pallet stacker 20 to determine a path of travel with respect to the beacon device 71.

Specifically, the pallet stacker 20 may include two different tracking modes, namely, front tracking mode (also known as “follow-me” mode) and rear tracking mode (also known as “me-follow” mode), as shown in FIG. 8 and FIG. 9 respectively. When the pallet stacker is switched to the front tracking mode, the pallet stacker 20, according to the beacon signal, is configured for traveling along a path with the pallet stacker 20 following the onsite operator 70 carrying the beacon device 71 from behind. For instance, the wearable carrier may be an apparel which holds the beacon device 71 on the back of the onsite operator 70. When the pallet stacker 20 is switched to the rear tracking mode, the pallet stacker 20, according to the beacon signal, is configured for traveling along a path in front of the onsite operator 70. That is, the onsite operator 70 controls the movements of the pallet stacker 20 based on his/her own movements by trailing behind the pallet stacker 20 at a predetermined distance. The pallet stacker 20 may determine the traveling speed of the onsite operator 70 and accordingly adjust its own traveling speed for maintaining the predetermined distance. Under the rear tracking mode, the pallet stacker 20 moves ahead of the onsite operator 70 without the need for engaging with the pallet stacker 20 using his/her hands. Preferably, the wearable carrier may hold the beacon device 71 at the front of the onsite operator 70. The above tracking functionalities may also be suitable to be implemented on manual operated material handling vehicles, such as a conventional pallet stacker.

It should be understood that although the specification is described in terms of embodiments, not every embodiment includes only a single technical solution. This description of the specification is merely for the sake of clarity. Those skilled in the art should regard the specification as a whole, and the technical solutions in the embodiments can also be combined appropriately to form other embodiments that can be understood by those skilled in the art. However, the protection scope of the present invention is defined by the appended claims rather than the foregoing description, and it is therefore intended that all changes that fall within the meaning and scope of equivalency of the claims are included in the present invention and any reference signs in the claims should not be regarded as limiting the involved claims.

All references specifically cited herein are hereby incorporated by reference in their entireties. However, the citation or incorporation of such a reference is not necessarily an admission as to its appropriateness, citability, and/or availability as prior art to/against the present invention.

What is claimed is:

1) A teleoperated material handling system, comprising:
a teleoperation terminal configured for collecting mechanical inputs from a teleoperator and converting to operation commands;
a material handling vehicle with a load engaging device for engaging an object;
a visual capturing module for capturing video imagery in front of the material handling vehicle;
a communication module for establishing a communication link with the teleoperation terminal for transmitting the video imagery to the teleoperation terminal and receiving the operation commands from the teleoperation terminal; and
a control module for controlling operations of the material handling vehicle and the load engaging device according to the operation commands;
wherein the system comprises an assistive module configured for providing one or more assistive indicators to the teleoperator through the teleoperation terminal, the one or more assistive indicators are dynamic with respect to changes in the operation commands, the one or more assistive indicators provide visual guidance through the teleoperation terminal for the teleoperator to manoeuvre the load engaging device so as to facilitate an alignment with the bottom of the object.

2) The teleoperated material handling system according to claim 1, wherein the one or more assistive indicators are superimposed over the video imagery on the display of the tele-operation terminal.

3) The teleoperated material handling system according to claim 2, wherein the one or more assistive indicators comprise one or more trajectory lines representing an anticipated trajectory of movement of the material handling vehicle.

4) The teleoperated material handling system according to claim 3, wherein the one or more trajectory lines change with respect to a change in steering input by the teleoperator according to Ackerman steering geometry.

5) The teleoperated material handling system according to claim 3, wherein the one or more trajectory lines change with respect to a change in a steering angle of at least one steerable wheel on the material handling vehicle.

6) The teleoperated material handling system according to claim 5, wherein the one or more trajectory lines change with respect to a change in traveling speed of the material handling vehicle.

7) The teleoperated material handling system according to claim 3, wherein perspective correction is performed for the one or more trajectory lines according to a perspective angle inherent in the video imagery.

8) The teleoperated material handling system according to claim 1, wherein the one or more assistive indicators are formed by projecting one or more laser beams from the load engaging device to form one or more markings on a surface.

9) The teleoperated material handling system according to claim 8, wherein the one or more assistive indicators are capturable and visible in the video imagery.

10) The teleoperated material handling system according to claim 9, wherein the one or more laser beams projected from one or more laser markers mounted on one or more load engaging portions of the load engaging device.

11) The teleoperated material handling system according to claim 9, wherein the one or more laser markers projects one or more longitudinal lines aligning with the one or more load engaging portions.

12) The teleoperated material handling system according to claim 1, wherein the system comprises a beacon device for providing a tracking functionality for the material handling vehicle.

13) The teleoperated material handling system according to claim 12, wherein the beacon device comprises a wearable carrier adapted to be worn by an onsite operator.

14) The teleoperated material handling system according to claim 13, wherein the beacon device emits a beacon signal receivable by the control module on the material handling vehicle, the control module is adapted for determining a path of travel for the material handling vehicle with respect to the beacon signal.

15) The teleoperated material handling system according to claim 14, wherein the material handling vehicle provides a front tracking mode such that the material handling vehicle travels along the path of travel with the material handling vehicle trailing the onsite operator carrying the beacon device.

16) The teleoperated material handling system according to claim 14, wherein the material handling vehicle provides a rear tracking mode such that the material handling vehicle travels along the path of travel in front of the onsite operator carrying the beacon device.

17) The teleoperated material handling system according to claim 14, wherein the system utilizes ultrawide band signal positioning to locate the beacon device for determining the path of travel.

18) The teleoperated material handling system according to claim 1, wherein the material handling vehicle is switchable between different operation modes including manual operation mode, teleoperation mode, and autonomous operation mode.

19) The teleoperated material handling system according to claim 16, wherein the material handling vehicle is switchable between different operation modes including manual operation mode, teleoperation mode, autonomous operation mode, front tracking mode and a rear tracking mode.

20) The teleoperated material handling system according to claim 1, wherein the communication link utilizes wireless communication protocols according to 5G mobile communication standards.

21) The teleoperated material handling system according to claim 1, wherein the communication link utilizes wireless communication protocols according to Wi-Fi standards.

22) The teleoperated material handling system according to claim 1, wherein the material handling vehicle is configured for self-navigating based on Simultaneous Localization and Mapping (SLAM).

23) The teleoperated material handling system according to claim 22, wherein the material handling vehicle is provided with a plurality of sensors comprising light detection and ranging (LiDAR), an inertial navigation system (INS), Global Positioning System (GPS), and high-definition maps (HD Map).

24) A material handling vehicle, comprising:
a load engaging device;
a control module for controlling movement of the material handing vehicle;
an assistive module configured for providing one or more assistive indicators to an operator, the one or more assistive indicators are dynamic with respect to a change in position of the load engaging device;
wherein the one or more assistive indicators are formed by projecting one or more laser beams from the load engaging device to form one or more markings on an object for indicating an alignment of the load engaging device with respect to the object.

25) The material handling vehicle according to claim 24, wherein the one or more laser beams projected from one or more laser markers mounted on one or more load engaging portions of the load engaging device.

26) The material handling vehicle according to claim 24, wherein the one or more laser markers projects one or more longitudinal lines aligns with the one or more load engaging portions.

27) The material handling vehicle according to claim 24, wherein the control module is configured for receiving a beacon signal emitted by a beacon device carried by the operator, the control module is adapted for determining a path of travel for the material handling vehicle with respect to the beacon signal.

28) The material handling vehicle according to claim 27, wherein the material handling vehicle provides a front tracking mode such that the material handling vehicle travels along the path of travel with the material handling vehicle trailing the operator carrying the beacon device.

29) The material handling vehicle according to claim 27, wherein the material handling vehicle provides a rear tracking mode such that the material handling vehicle travels along the path of travel in front of the operator carrying the beacon device.

30) The material handling vehicle according to claim 27, wherein the control module utilizes ultrawide band signal positioning to locate the beacon device for determining the path of travel.
